(19) United States
(12) Patent Application Publication
(10) Pub. No.: US 2023/0029313 A1
(43) Pub. Date: Jan. 26, 2023

(54) SEALING ASSEMBLY FOR INSERTION BETWEEN A STATIONARY ANNULAR ELEMENT AND A ROTATING ANNULAR ELEMENT, IN PARTICULAR BETWEEN THE OUTER AND INNER RINGS OF A ROLLING BEARING AND ASSOCIATED WHEEL HUB UNIT

(71) Applicant: AKTIEBOLAGET SKF, Göteborg (SE)

(72) Inventors: Davide Bergesio, Chieri (IT); Daniele Duch, San Gillio (IT); Fabio Nosenzo, Asti AT (IT)

(21) Appl. No.: 17/859,440

(22) Filed: Jul. 7, 2022

(30) Foreign Application Priority Data
Jul. 15, 2021 (IT) 102021000018632

(51) Int. Cl. F16J 15/3232; F16J 15/3244; F16J 15/447

(52) U.S. Cl. CPC F16J 15/3232; F16J 15/3244; F16J 15/447; F16C 33/72

(57) ABSTRACT

In a wheel hub unit a sealing assembly inserted between a stationary outer ring and a rotating inner ring of a rolling bearing includes a first screen coupled with the outer ring, an elastomeric annular element attached to the first screen, and a second screen faces the first screen and coupled with the inner ring, the second screen having a flange portion with a radially outer edge facing a sleeve portion of the first screen, the first screen having a non-contacting annular lip with a free end substantially flush in a radial direction with the radially outer annular edge, the free end cooperating with the radially outer edge to form a labyrinth seal.

### CROSS-REFERENCE OF RELATED APPLICATIONS

This application is based on and claims priority to Italian Patent Application No. 102021000018632 filed on Jul. 15, 2021, under 35 U.S.C. § 119, the disclosure of which is incorporated by reference herein.

### FIELD

The present disclosure relates to sealing assemblies for a bearing unit of a wheel hub.

### BACKGROUND

In wheel hubs, sealing assemblies are used to prevent the flow of external contaminants into an internal area of a bearing unit of a wheel hub unit for a vehicle.

### BRIEF DESCRIPTION OF THE DRAWINGS

The disclosure will now be described with reference to the attached drawings which illustrate non-limiting exemplary embodiments thereof, in which:

FIG. 1 illustrates a schematic, elevation view of a radial section of a wheel hub unit including a sealing device assembly according to exemplary embodiments of this disclosure;

FIG. 2 illustrates a schematic, elevation view of a radial section of a wheel hub unit including a sealing device assembly having a rotating screen formed in part by radial blanking according to exemplary embodiments of this disclosure;

FIG. 3 illustrates a schematic, elevation view of a radial section of a wheel hub unit including a sealing device assembly having a rotating screen with a flat flange portion according to exemplary embodiments of this disclosure; and

FIG. 4 illustrates a schematic, elevation view of a radial section of a wheel hub unit including a sealing device assembly having a rotating screen formed in part by axial blanking according to exemplary embodiments of this disclosure.

### DETAILED DESCRIPTION

In bearing units, sealing assemblies may be inserted between opposite axial ends of an inner and an outer ring of a rolling bearing. The sealing assemblies are designed to prevent entry of external contaminants, such as water, dust, and mud, inside an annular cavity defined between the inner and outer ring, which houses rolling bodies that make the inner ring and the outer ring rotatable relative to each other with low friction.

In a vehicle wheel hub unit, a side which is most exposed to entry of contaminants is an outer or outboard (OB) side of a vehicle. In such a wheel hub unit, the inner ring is designed to rotate and is provided with (or is integral with) an annular flange, which supports a vehicle wheel during use.

Improving the hydraulic sealing capacity of so-called “cassette” sealing assemblies, which are commonly used in the OB position of the bearing, without influencing the friction is a challenge during design of sealing assemblies for bearings. Known cassette sealing assemblies are normally composed of two substantially rigid annular screens that are mounted coaxially and facing each other, a first screen being integral with the outer ring, stationary during use, and a second screen being integral with the inner ring, rotating during use. The first screen may also be provided with one or more annular sealing lips made of an elastomer to be elastically flexible. One lip forms a hydraulic seal by making sliding interfering contact with the second screen, while the other sealing lip is configured to form a labyrinth seal, and therefore is a non-contacting sealing lips.

Problems relating to entry of water/contaminants in the rolling bearings depends on quantity of water/contaminants that manage to reach a sealing zone of the sealing assembly defined by the sliding-contact lip. The sliding contacting lip is unable to receive an excessive accumulation of water/contaminants on it without gradually losing part of its sealing capacity. By increasing the interference of the sliding-contact lip with the second screen, this sealing capacity is increased, but friction is also increased, resulting in high energy consumption and premature wear of the sliding-contact lip.

Improving the labyrinth seal offered by the non-contacting lip, which is able to reduce the quantity of contaminants reaching the sliding-contacting lip (for example by multiplying the number of these lips), also appears to be problematic owing to limited radial space available for mounting the sealing assembly. An object of the present disclosure is to provide an improved sealing assembly which overcomes the drawbacks of known sealing assemblies while being simple low-cost to manufacture, being compact in terms of dimensions, in particular dimensions in the radial direction, and by having a high sealing efficiency and low friction.

It is a further object of this disclosure to provide an associated wheel hub unit for vehicles, equipped with such a sealing assembly.

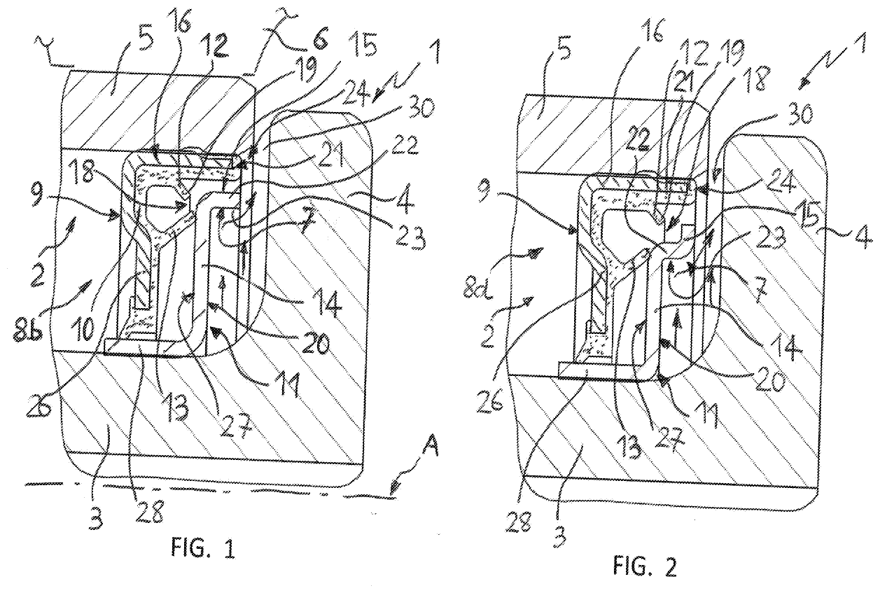

With reference to FIG. 1, a vehicle wheel hub unit 1 may include a rolling bearing 2.

In various embodiments, a rolling bearing 2 includes a radially inner ring 3, rotatable about an axis A and angularly integral with an annular flange 4 configured to receive, during use, a vehicle wheel (not shown for simplicity of illustration), and a radially outer ring 5, stationary and configured to be coupled integrally, during use, with a vehicle suspension upright 6. It should be appreciated that alternative embodiments of wheel hub unit 1 may include a stationary inner ring 3 and a rotatable outer ring 5 without departing from the scope of this disclosure.

In various embodiments, annular flange 4 may be formed integrally as one piece with inner ring 3. In alternative embodiments, annular flange 4 may be formed integrally with a spindle (not shown) on which inner ring 3 may be mounted angularly integral.

Vehicle wheel hub unit 1 may further include a sealing assembly, e.g., 8b, 8c, 8d, 8e inserted between inner ring 3 and outer ring 5 on a side where annular flange 4 is located. In general, a sealing assembly 8 may be inserted between any first and second annular elements, e.g., an inner ring 3 and an outer ring 5, coaxial with respect to axis A.

With reference to FIG. 1, a sealing assembly 8b may include a substantially rigid first annular screen 9 coupled integrally as one piece with a first elastomeric annular element 10, and a substantially rigid second annular screen 11 arranged coaxially (with respect to axis A) with first annular screen 9 and facing first elastomeric annular element 10. In various embodiments, first annular screen 9 may be configured to be stationary during use.

Elastomeric annular element 10 may be provided with a plurality of annular sealing lips. In various embodiments, the plurality of annular sealing lips may include a radially outer first annular sealing lip 12 and a radially inner second annular sealing lip 13, both extending from first screen 9 and towards second screen 11. As shown in FIG. 1, first sealing lip

Second screen 11 may include a first flange portion 14 provided with a radially outer annular edge 15 arranged facing a corresponding first sleeve portion 16 of first screen 9.

First sleeve portion 16 may have a cylindrical geometry coaxial with axis A and be configured to couple with a stationary annular element, e.g., outer ring 5. In various embodiments, first sleeve portion 16 may be configured to couple with stationary outer ring 5 by means of force fitting.

Second screen 11 may further include a sleeve portion 28 configured to force-fit second screen 11 angularly integral with inner ring 3 and thereby rotate during use. In this way, second annular element 11 may be a centrifuging element. Sleeve portion 28 may be arranged coaxially with sleeve portion 16, and flange portion 14 may extend radially from sleeve portion 28.

In various embodiments, elastomeric annular element 10 may cover a radially inner surface of first sleeve portion 16. First annular sealing lip 12 may be provided integrally by means of molding with elastomeric annular element 10 and extend towards second screen 11 without making contact with second screen 11. Second annular lip 13 may additionally be formed integrally with elastomeric annular element 10 by means of molding.

First annular sealing lip 12 may be configured to form a labyrinth seal 18 together with radially outer edge 15 of first flange portion 14. In particular, labyrinth seal 18 may be formed by a free end 19 of first annular lip 12 and radially outer annular edge 15.

Radially outer annular edge 15 may be arranged substantially flush with free end 19 of first lip 12 to minimize radial interference with free end 19 in a radial direction. In various embodiments, radially outer annular edge 15 may be substantially flush with free end 19 such that radially outer annular edge 15 is positioned radially more on an outside of free end 19.

In various embodiments, free end 19 of first annular lip 12 may have a radially inner diameter substantially equal to, or smaller than, a radially outer diameter of radially outer annular edge 15, defining a minimum radial interference between free end 19 and annular edge 15 of between 0 mm and 1 mm.

Radially outer edge 15 of first flange portion 14 may be shaped so as to form a radial shield 7 that extends axially away from a front face 20 of first flange portion 14 of second screen 11. In various embodiments, first flange portion 14 may be folded in an axial direction away from first screen 9 so as to further define a cylindrical sleeve section 22 arranged concentrically with outer annular edge 15 and on a radially inner side of an axial end portion 21 of a first sleeve portion 16. In such embodiments, radial shield 7 may be defined by a radially inner side surface 23 of cylindrical sleeve section 22.

Front face 20 of first flange portion 14 may face in a direction opposite to the first screen 9, so that radial shield 7 extends axially away from first screen 9.

Radial shield 7 may be configured to divert external contaminants away from the labyrinth seal 18 by means of a hydrodynamic effect resulting from rotation of second screen 11 about axis A, as illustrated by directional arrows in FIGS. 1, 2, 3, and 4.

In various embodiments, first screen 9 includes a second flange portion 26 extending radially towards sleeve portion 16 and axially faces first flange portion 14.

Second flange portion 26 may be provided with second annular sealing lip 13 extending axially towards second screen 11 and cooperating by interference contact with a second front face 27 of first flange portion 14. In various embodiments, front face 27 may face first screen 9 and be arranged parallel to face 20 on an opposite axial side of first flange portion 14.

In various embodiments, second annular lip 13 may be arranged radially inside of first annular lip 12, i.e., radially between first annular lip 12, and therefore is located arranged radially downstream of labyrinth seal 18, where “downstream” refers to a direction of penetration of any external contaminants between first screen 9 and second screen 11.

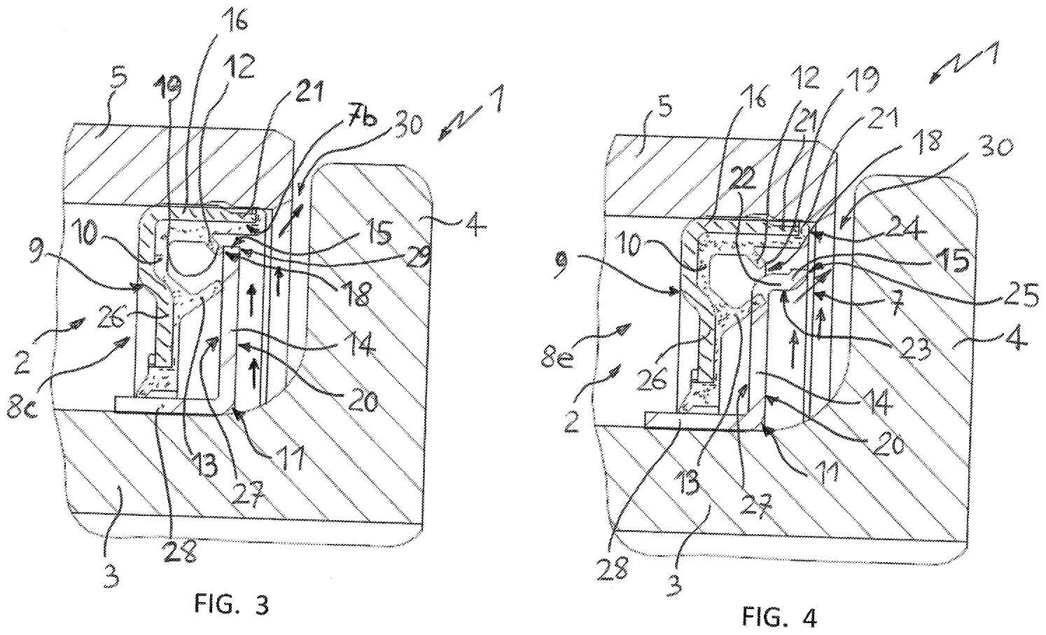

In various embodiments, a sealing device 8c, as seen in FIG. 3, may include a first flange portion 14 of second screen 11 that may be rectilinear, flat, and arranged axially on an inside of first sleeve portion 16 of first screen 9.

A corresponding axial end portion 21 of sleeve portion 16 may be located on a side opposite first flange portion 14 and extend axially beyond an axial position of front face 20. In various embodiments, axial end portion 21 may be lined with elastomeric annular element 10 and form a radial shield 7b with part of the elastomeric annular element 10 that extends axially beyond front face 20. Radial shield 7b may be configured to divert external contaminants away from labyrinth seal 18 by means of a hydrodynamic effect resulting from rotation of second screen 11. Radial shied 7b may be defined by axial end portion 21.

In various embodiments of a sealing device, e.g., 8d, flange portion 14 of the second screen 11 may be further folded by means of radial blanking in a radially outward direction providing radially outer annular edge 15 with an L shape in a radial cross-section of wheel hub unit 1.

L-shaped radially outer annular edge 15 of sealing assembly 8dmay be arranged flush with an end edge 24 of axial end portion 21.

In various embodiments, a sealing assembly 8e may form radially outer annular edge 15 by means of axial blanking, forming an incomplete L-shape. Due to axial blanking, outer annular edge 15 may include and end corner 25 that defines a conical, radially arranged leg of the incomplete L-shape. End corner 25 increases the centrifuging efficiency of second screen 11 during use.

In various embodiments of a sealing device, e.g., 8b, 8c, 8d, 8e, free end 19 of first annular lip 12 may be arranged closer axially towards first screen 9 and further away from radially outer annular edge 15 of flange portion 14 such that free end 19 of annular lip 12 never projects axially beyond front face 20 of flange portion 14.

In various embodiments, second screen 11 may be integrally coupled with rotating inner ring 3 and first screen 9 may be integrally coupled with stationary outer ring 5. Radial shield, e.g., 7, 7b may be arranged adjacent to annular flange 4 and separated by a predefined axial gap 30.

In various embodiments, front face 20 may be facing towards axial gap 30 and configured to generate, as a result of rotation of inner ring 3, a centrifugal flow that directs contaminants towards radial shield 7, 7b (illustrated in FIGS. 1-4 by directional arrows) that would normally be directed towards labyrinth seal 18.

A radial shield consistent with this disclosure, e.g., 7, 7b, is similarly configured to divert centrifugal flow of contaminants towards axial gap 30 and expel external contaminants away from labyrinth seal 18.

First annular sealing lip 12, also known as an exclusion lip, may therefore be designed to create labyrinth seal 18 with an L-shaped screen 11 in order to improve protection of a main sealing area formed by second annular sealing lip 13 and reduce direct flow of water and external contaminants in the main sealing area. Similarly, flange portion 14 of the annular screen 11 is designed to divert contaminants by a centrifugal force resulting from rotation and proximity to annular flange 4 in order to facilitate the flow of water and external contaminants outside of wheel hub unit 1.

All objects of this disclosure are therefore achieved.

We claim:

1. A sealing assembly insertable between an outer ring and an inner ring of a rolling bearing forming part of a wheel hub unit of a vehicle, comprising:
a substantially rigid first annular screen configured to be stationary during use, the first annular screen comprising a first sleeve portion configured to couple with the outer ring;
a substantially rigid second annular screen arranged coaxially with the first annular screen and facing the first elastomeric annular element, the second annular screen comprising:
a first flange portion provided with a radially outer annular edge facing the first sleeve portion of the first annular screen during use, the first flange configured to couple with the inner ring, wherein the second annular screen is configured to rotate during use; and
a first elastomeric annular element integrally coupled with the first annular screen, the first elastomeric annular element comprising a plurality of annular sealing lips; wherein,
the first sleeve portion is provided with a first annular sealing lip of the plurality of annular sealing lips extending radially towards the second annular screen without making contact with the second annular screen, the first annular sealing lip comprising a free end,
the first annular sealing lip and the radially outer annular edge define a labyrinth seal between the free end of the first annular sealing lip and the radially outer annular edge of the first flange portion of the second screen, and
the radially outer annular edge is substantially flush with the free end of the first sealing lip, creating radial interference between the free end and the radially outer annular edge, and axially spaced from the free end.

2. The sealing assembly according to claim 1, wherein the free end of the first annular lip has a radially inner diameter substantially equal to, but not larger than, a radially outer diameter of the radially outer annular edge of the first flange portion.

3. The sealing assembly according to claim 2, wherein the radial interference between the free end of the first annular sealing lip and the radially outer annular edge is between 0 mm and 1 mm.

4. The sealing assembly according to claim 1, wherein,
the first flange portion of the second annular screen comprises a first front face axially facing away from the first annular screen,
the first sleeve portion further comprises an axial end portion extending axially beyond the front face of the first flange portion and opposing radially the first flange portion, and
the axial end portion forms a radial shield configured to divert external contaminants away from the labyrinth seal by mean of a hydrodynamic effect resulting from rotation of the second screen during use.

5. The sealing assembly according to claim 1, wherein,
the first flange portion of the second annular screen comprises a first front face axially facing away from the first annular screen,
the radially outer annular edge extends axially beyond the front face of the first flange portion, forming a radial shield configured to divert external contaminants away from the labyrinth seal by mean of a hydrodynamic effect resulting from rotation of the second screen during use.

6. The sealing assembly according to claim 4, wherein the first flange portion of the second screen is straight and flat.

7. The sealing assembly according to claim 5, wherein,
the first flange portion of the second screen is folded axially away from the first annular screen, defining with the radially outer annular edge a cylindrical sleeve section arranged concentrically with the radially outer annular edge and radially opposite an axial end portion of the first sleeve portion of the first annular screen, and a radially inner side surface of the cylindrical sleeve section further defines the radial shield.

8. The sealing assembly according to claim 7, wherein,
the radially outer annular edge is formed into a complete L-shape by radial blanking, wherein an axial end of the cylindrical sleeve section is folded radially toward the axial end portion of the first sleeve portion, and
the radially outer annular edge of the first flange portion is arranged flush with an end edge of the axial end portion of the first sleeve portion.

9. The sealing assembly according to claim 7, wherein,
the radially outer annular edge is formed into an incomplete L-shape by axial blanking, wherein an axial end of the cylindrical sleeve section is folded radially toward the axial end portion of the first sleeve portion, and
the radially outer annular edge of the first flange portion is arranged flush with an end edge of the axial end portion of the first sleeve portion.

10. The sealing assembly according claim 4, wherein the first screen further comprises:
a second flange portion extending radially from the first sleeve portion; and
a second annular sealing lip extending axially from the second flange portion towards the second screen and cooperating by interference contact with a second front face of the first flange portion on a side axially opposite the first front face,
wherein the second annular sealing lip is arranged downstream of the labyrinth seal.

11. The sealing assembly according claim 5, wherein the first screen further comprises:
a second flange portion extending radially from the first sleeve portion; and
a second annular sealing lip extending axially from the second flange portion towards the second screen and cooperating by interference contact with a second front face of the first flange portion on a side axially opposite the first front face,
wherein the second annular sealing lip is arranged downstream of the labyrinth seal.

12. The sealing assembly according to claim 4, wherein the free end of the first annular sealing lip is arranged axially to never protrude axially beyond the first front face of the first flange portion.

13. The sealing assembly according to claim 5, wherein the free end of the first annular sealing lip is arranged axially to never protrude axially beyond the first front face of the first flange portion.

14. A wheel hub unit for vehicles, comprising:
an annular flange configured to receive, during use, a vehicle wheel; to be coupled integrally with
a vehicle suspension upright,
a rolling bearing comprising a rotating radially inner ring angularly integral with the annular flange and a stationary radially outer ring coupled integrally with the vehicle suspension upright; and
a sealing assembly arranged between the inner ring and the and outer ring on a side of the annular flange, the sealing assembly comprising:
a substantially rigid first annular screen configured to be stationary during use, the first annular screen comprising:
a first sleeve portion,
wherein the first annular screen is coupled to the stationary outer ring;
a substantially rigid second annular screen arranged coaxially with the first annular screen and facing the first elastomeric annular element, the second annular screen comprising:
a first flange portion provided with a radially outer annular edge facing the first sleeve portion of the first annular screen,
wherein the first flange portion comprises a first front face axially facing away from the first annular screen, and
wherein the second annular screen is coupled to the rotating inner ring and is configured to rotate during use; and
a first elastomeric annular element integrally coupled with the first annular screen, the first elastomeric annular element comprising a plurality of annular sealing lips;
wherein
the first sleeve portion is provided with a first annular sealing lip of the plurality of annular sealing lips extending radially towards the second annular screen without making contact with the second annular screen, the first annular sealing lip comprising a free end,
the first annular sealing lip and the radially outer annular edge define a labyrinth seal between the free end of the first annular sealing lip and the radially outer annular edge of the first flange portion of the second screen,
the radially outer annular edge is substantially flush with the free end of the first sealing lip radially, creating radial interference between the free end and the radially outer annular edge, and axially spaced from the free end,
the radially outer annular edge extends axially beyond the front face of the first flange portion, forming a radial shield, the radial shield arranged adjacent to the first annular flange and separated from an axially inner face of the inner ring by an axial gap,
the first front face of the first flange portion facing the axial gap and configured to generate a centrifugal flow of external contaminants toward the radial shield and away from the labyrinth seal as a result of rotation of the inner ring, and
the radial shield is configured to divert the centrifugal flow of external contaminants away from the labyrinth seal by mean of a hydrodynamic effect resulting from rotation of the second screen during use.
